(19) United States
(12) Patent Application Publication
(10) Pub. No.: US 2006/0022174 A1
(43) Pub. Date: Feb. 2, 2006

(54) Electroactive chemical composition and method of coating

(75) Inventors: Svetlana Rogojevic, Niskayuna, NY (US); Anil Raj Duggal, Niskayuna, NY (US); Dennis Joseph Coyle, Clifton Park, NY (US); Alvin Un-Teh Chen, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/899,099

(22) Filed: Jul. 27, 2004

(51) Int. Cl. B05D 5/06; B05D 1/02; C09K 11/06

(52) U.S. Cl. 252/500; 427/421.1; 427/66; 252/301.16

(57) ABSTRACT

A method for depositing a chemical composition on a substrate is disclosed. The method comprises providing the substrate, providing the chemical composition that comprises an electroactive compound in a liquid form such that the contact angle of a drop of the liquid on the surface of the substrate allows the drop to spread and together with adjacent drops to form a substantially continuous film.

### BACKGROUND OF THE INVENTION

The present invention relates to the coating of substrates for microelectronics and other applications. In particular, the present invention relates to substrates coated with a chemical composition and provides a method therefor.

A wide variety of substrates are used in the microelectronics industry including paper, plastics, ceramics, metals, glass, composites, alloys and others. The substrates are frequently coated with a wide variety of coating materials including polymers, metal, ceramic, composites, alloys, or other materials in a range of coating thicknesses and properties to suit the requirement. In addition, substrates may be coated using a variety of means such as spraying, dip-coating, spin coating, physical vapor deposition, sputtering, chemical vapor deposition, doctor blading, and other techniques. Techniques such as spraying, dip-coating and spin coating particularly suit the continuous processing requirements in the electronics industry.

Spraying is generally used to coat relatively large substrate areas such as device panels and large components. A substantial material wastage occurs during spraying along with the possibility of coating coverage outside the substrate. Besides, coating thickness is found to vary inversely with the cosine of the angle subtended from the point of spraying. Dip-coating, by virtue of inherent design, provides a coating on all the surfaces that immerse into a coating solution which may not be acceptable for many electronics applications. Spin coating is often used in the fabrication of semiconductor devices, films of photoresist materials, anti-reflective materials, light emitting materials, low dielectric constant materials and other coatings over a substrate. In a typical spin-coating operation, a coating is applied over the surface of a substrate and the substrate is spun at high speeds in a spin bowl. The centrifugal force caused by the rotation of the substrate causes the coating to spread over the surface and form a film. Excess coating fluid that spins off the surface of the substrate drains from the spin bowl and is collected in a drain bowl disposed below the spin bowl.

Unfortunately, the formation of coatings over substrates by spin coating has at least five significant drawbacks. First, spin coating consumes a large quantity of the material being applied on the surface of the substrate. In a typical spin coating operation, approximately 95% of the material initially applied on the surface of the substrate is spun off during the operation. Second, the excess material generated during the spin coating operation must be disposed off in accordance with relatively expensive waste management procedures to minimize the impact on the environment. Third, spin coated substrates typically require edge bead removal to provide a clean edge area that can be gripped by robotic substrate handling equipment. The solvents used in edge bead removal processes also must be disposed off in accordance with waste management procedures. Fourth, spin coated substrates typically require backside rinsing to remove contaminants from the backside of the substrate. Fifth, spin coating does not afford a wide range of film thickness control in that the viscosity of a material limits the minimum film thickness and the maximum film thickness that can be obtained at a reasonable coating uniformity. Consequently, it may not be possible to obtain a specified film thickness for a given material by spin coating.

Therefore, there is a continued need to provide a method for uniformly depositing a chemical composition on a substrate. It is also desirable to provide a chemical formulation to achieve a uniform coating thereof.

### BRIEF SUMMARY OF THE INVENTION

The present invention provides a chemical composition comprising an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid. A viscosity of 1 mPas (or 1 milli Pascal second) corresponds to a viscosity of 1 cP (or centi Poise) which is also a commonly used unit of viscosity.

A second embodiment of the invention provides a method for depositing a chemical composition on a substrate. The method comprises: (a) providing the substrate; (b) providing the chemical composition that comprises an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid; (c) discharging a jet of the chemical composition from a nozzle, the jet having a velocity in a range from about 1 to about 10 m/s at the nozzle; and (d) allowing the jet to break up into droplets, and allowing the droplets to impinge on the substrate.

A third embodiment of the invention provides a method of forming a substantially continuous film of a chemical composition on a substrate. The method comprises: (a) providing the substrate, providing the chemical composition that comprises an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid; (c) discharging substantially simultaneously a plurality of jets of the chemical composition from a plurality of nozzles, each jet having a velocity in a range from about 1 to about 10 m/s at a nozzle; and (d) allowing the jets to impinge on the substrate to form a plurality of interconnected drops, thereby forming the substantially continuous film of the chemical composition.

Other features and advantages of the present invention will be apparent from a perusal of the following detailed description of the invention and the accompanying drawings in which the same numerals refer to like elements.

### BRIEF DESCRIPTION OF THE DRAWINGS

It should be understood that the drawings accompanying this disclosure are not drawn to scale.

FIG. 1 illustrates a method for depositing a chemical composition on a substrate using the present invention;

FIG. 2 illustrates a single coating drop deposited on a substrate using the present invention and indicates the contact angle of the drop at the substrate; and

FIG. 3 illustrates a method for depositing a continuous film of a chemical composition on a substrate using the present invention.

### DETAILED DESCRIPTION OF THE INVENTION

In general, the present invention provides a method for depositing a chemical composition on a substrate. The method comprises: (a) providing the substrate; (b) providing the chemical composition that comprises an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid; (c) discharging a jet of the chemical composition from a nozzle, the jet having a velocity in a range from about 1 to about 10 m/s at the nozzle; and (d) allowing the jet to break up into droplets, and allowing the droplets to impinge on the substrate.

The process of depositing a coating on a substrate and the characteristics of a coating thus obtained, depends upon many factors that include the interfacial interaction (i.e., the interaction between surface tension or surface energy at the liquid and solid surfaces) between the coating and the substrate, the viscosity of the coating fluid, the vapor pressure of the coating fluid and the method of coating and drying.

In coating processes, like ink-jet printing or nozzle printing that involve the discharge of a coating fluid through a nozzle, it is possible to uniquely develop the method and coating formulation to obtain desired microelectronic patterning or coating on a substrate to meet closely specified tolerances. Such tolerances would not be easily obtainable by conventional microelectronic processing means such as spraying, dip-coating or spin coating. In situations that require the development of microscopically fine, high resolution microelectronic detail such as leads, electrodes, contact points, textured panels and structured layers for electroactive applications, nozzle printing is particularly suited. In one aspect, the present invention provides a method and a composition for depositing an electroactive material on a surface with high tolerances.

Interfacial interaction, as understood in the present invention, is a measure of the relative surface energy between the substrate and the coating fluid and is usually defined as the difference between the surface energy of the substrate and the surface tension of the coating fluid. The interfacial interaction between the substrate and the coating fluid determines whether a drop on the surface of the substrate spreads on the substrate according to a desired pattern. It is possible to influence the interfacial interaction between the substrate and the coating fluid by physically or chemically modifying the properties of either the substrate or the coating fluid, or both. Altering the interfacial interaction alters the shape of the drop at the fluid-substrate interface.

The contact angle of a drop on a surface, is defined as the angle between a tangent drawn on the drop's surface at the resting or contact point and a tangent to the supporting surface. The contact angle determines the shape of a drop at the surface and reveals information about the chemical interaction between the liquid and the surface. The chemical interaction between the liquid and the surface determines the wettability (or drop spread) and adhesion. Contact angles in excess of 90 degrees usually denote a hydrophobic surface causing the drop to bead-up on the surface. Low contact angles, usually below 25 degrees, cause the drop to spread on the surface.

Another physical property that determines the flow of a drop on the surface of a substrate, is viscosity. Viscosity, defined as the rate of energy dissipation in a flowing fluid, manifests as the resistance of the fluid to flow. The viscosity of a fluid depends upon its chemical composition and is usually measured in centipoises (cP). The SI unit of viscosity is Pascal second (Pas) and 1 cP is equal to 10⁻³ Pas.

The chemical composition of the drop i.e., the concentration of a desired solid species distributed in the fluid also determines the flow and spread of the drop on the substrate of the surface. The drying time of a drop are typically determined by viscosity, surface tension, drop size, drop density, impact velocity, and vapor pressure of the fluid. In patterned or coated microelectronic devices, it is desired that the coating have easy flow and fast drying. It is hence desirable that the liquid has a high vapor pressure, for example, the liquid should have a boiling point in a range from about 100° C. to about 200° C.

The surface texture or smoothness of the substrate on which the drop is to be coated also determines the extent to which the drop spreads on the surface. Since the surface energy of the substrate depends on surface chemistry, and also on the surface smoothness, the contribution of surface texture to drop flow and spread is already considered.

The chemical composition of a coating formulation is developed after due consideration of the contact angle, viscosity, boiling point and concentration parameters applicable for the substrate-coating fluid system. The coating fluid is typically discharged in a jet and allowing the jet to impinge on the substrate to form a coating on the substrate. The coating precision, defined as the variance in the actual location of the coated drop from its intended position on the substrate, typically depends on the velocity of the coating jet as it discharges from the nozzle. The jet velocity of the coating is usually calibrated in terms of fluid viscosity, and distance between the nozzle and the substrate and control and design factors at the nozzle. A low jet velocity leads to poor precision of coating on the substrate whereas a high jet velocity leads to the formation of ‘satellites’, i.e., additional deposits of coating in undesired areas of the substrate. In electronic applications requiring a precise deposition of an electroactive compound on a substrate, the presence of coating satellites is unacceptable.

Typical electroactive materials that may be deposited on a substrate using the present invention are light emitting polymers, photovoltaic materials, organometallic compounds, charge transfer polymers, and combinations thereof.

Typical light emitting polymers that may be deposited on a substrate include poly(n-vinylcarbazole) (also known as “PVK”), polyfluorene, poly(alkylfluorene), poly(paraphenylene), poly(p-phenylene vinylene), polysilanes, polythiophene, poly(2,5-thienylene vinylene), poly(pyridine vinylene), polyquinoxaline, polyquinoline, 1,3,5-tris {n-(4-diphenylaminophenyl) phenylamino}benzene, phenylanthracene, tetraarylethene, coumarin, rubrene, tetraphenylbutadiene, anthracene, perylene, coronene, and derivatives thereof, aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metallic complexes of 8-hydroxyquinoline, and derivatives of organo-metalic complexes of 8-hydroxyquinoline, and combinations thereof.

Typical charge transfer polymers that may be deposited on a substrate include polyethylenedioxythiophene (PEDOT), poly(3,4-propylenedioxythiophene) (PProDOT), and combinations thereof.

The electroactive compound is formulated in a liquid carrier that is selected from the group consisting of water, isopropanol, ethylene glycol, a surfactant, anisole, tetralin, toluene, chlorobenzene, p-xylene, mesitylene, 4-methylanisole, orthodichlorobenzene, methyl benzilate, decalin, 1,2,3,5-tetramethyl benzene, methylbenzoate, alphaterpineol, and combinations thereof.

The coating of electroactive compound can be disposed on a variety of substrates including paper, plastics, polymers, ceramics, metals, glass, composites, alloys, and combinations thereof.

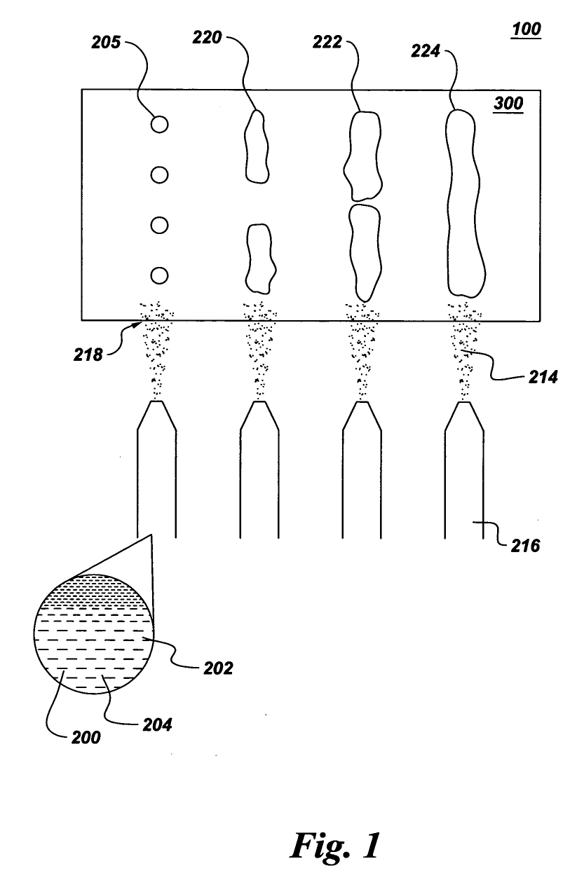

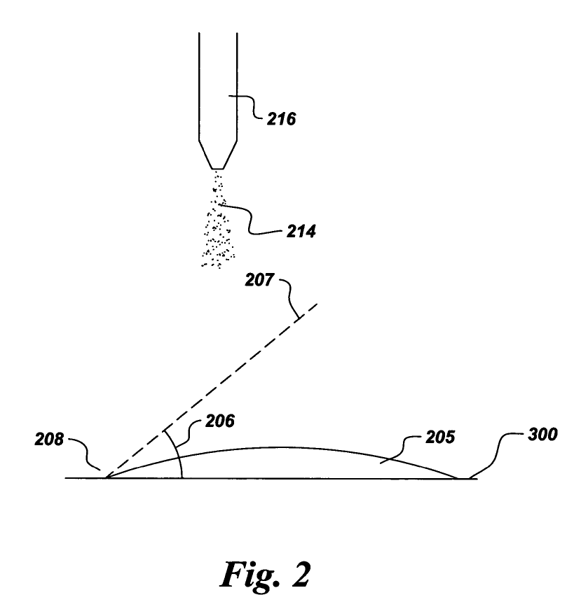

Turning to FIGS. 1 and 2 for a general representation of the present invention, the invention provides a method 100 for depositing a chemical composition 200 on a substrate 300. The method 100 comprises providing the substrate 300, providing the chemical composition 200 that comprises an electroactive compound 202 in a liquid 204. A drop of the liquid 205 on substrate 300 has a contact angle 206 in a range from 0 to about 20 degrees, the liquid having a viscosity in a range from about 2 to about 20 mPas, the liquid having a boiling point in a range from about 100° C. to about 200° C., and the concentration of the electroactive compound 202 in the liquid 204 being in a range from about 0.01 to about 4 grams of the electroactive compound 202 per cubic centimeter of liquid 204. The chemical composition 200 is discharged in a jet 214 from a nozzle 216, the jet 214 having a velocity in a range from about 1 to about 10 m/s at the nozzle 216. The jet 214 is allowed to break up into droplets, which impinge on the substrate 300 to deposit the chemical composition 200 on the substrate 300.

In one embodiment of the present invention, the drop of the liquid 205 on substrate 300 has a contact angle in a range from 0 to about 15 degrees and more preferably, in a range from about 0 to about 5 degrees. As generally shown in FIG. 2, contact angle 206 is defined as the angle between a tangent 207 drawn on the drop's surface at the resting or contact point 208 and a tangent to the supporting surface along substrate 300. In another embodiment of the present invention, the liquid has a viscosity in a range from about 8 to about 12 mPas. In still another embodiment of the present invention, the liquid has a boiling point in a range from about 130° C. to about 180° C.

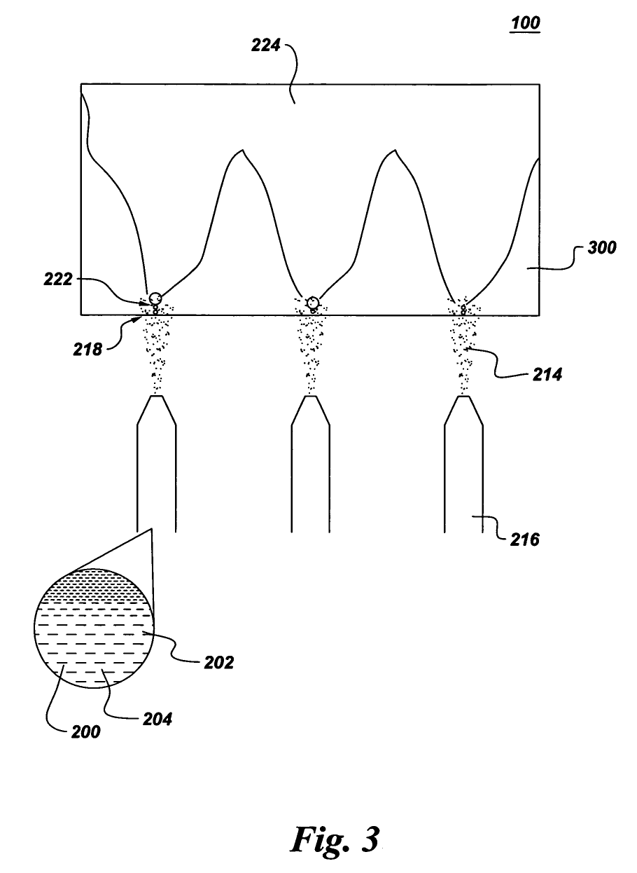

In one embodiment of the invention shown in FIG. 3, the invention also provides a method 100 of forming a substantially continuous film 224 of a chemical composition 200 on a substrate 300. The method comprises providing the substrate 300, providing the chemical composition 200 that comprises an electroactive compound 202 in a liquid 204. A drop of the liquid 205 on a substrate 300 has a contact angle 206 in a range from 0 to about 20 degrees, the liquid having a viscosity in a range from about 2 to about 20 mPas, the liquid having a boiling point in a range from about 100° C. to about 200° C., and the concentration of the electroactive compound 202 in the liquid 204 being in a range from about 0.01 to about 4 grams of the electroactive compound 202 per cubic centimeter of liquid 204. The chemical composition 200 is discharged substantially simultaneously through a plurality of jets 214 of the chemical composition 200 from a plurality of nozzles 216, each jet 216 having a velocity in a range from about 1 to about 10 m/s at a nozzle 216, and allowing the jets 214 to impinge on the substrate 300 to form a plurality 220 of interconnected drops 222, to form the substantially continuous film 224 of the chemical composition 200.

In another embodiment, the invention also provides a chemical composition comprising an electroactive compound in a liquid. A drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid.

The following Examples illustrate some preferred embodiments and modes of operation in the present invention.

### EXAMPLE 1

### PEDOT Jetting

A fine suspension of PEDOT (polyethylenedioxythiophene) was prepared in water comprising a concentration of 2.6 grams of solid per cubic centimeter of liquid. The viscosity of the solution was 14 mPas. This solution is commercially available as Baytron P VP CH 8000.

The coating solution was loaded in a commercially available printhead (Galaxy PH 256/30 LQ, manufactured by Spectra Inc., 101 Etna Road, Lebanon N.H. 03766). The printhead was a 256-nozzle printhead with a 25-30 picoliter drop size, intended for jetting a broad range of liquids, including aqueous and solvent based liquids. The printhead included the liquid reservoir, on-reservoir de-aeration chamber and electronics interface board for serial data transmission. Within the printhead's jetting assembly, four electrically independent jetting modules, each with 64 addressable channels were combined to provide a total of 256 jets. The nozzles were arranged in a single line at a spacing of 0.010 inch (or 0.0254 mm) to provide a resolution of 100 dots per inch (dpi). A high voltage fire pulse with controlled slew rates was used to actuate the piezo elements of the pumping chambers within each channel. The channels were individually addressable in terms of being turned on or off, but within each jetting module (consisting of 64 channels) different channels were not configured to receive different voltage within a jetting cycle. The printhead was normally operated under a slight vacuum applied to the top of the reservoir that helped maintain the meniscus shape at the nozzles and prevents fluid weeping at the printhead. The printhead was designed to work with liquids having of 8-20 mPas viscosity and 24-36 dynes/cm surface tension. The initial conditions were an operating voltage of 100 V and 8 micro-second of pulse duration controlled using a personal computer interface.

The coating solution was printed on the substrate and jetting from the nozzles was observed visually and also modeled using a Design Expert software version 6.0 using the ANOVA tool. Since the presence of satellites was evaluated as attribute data only (0 or 1), it did not correlate with the signal duration and the applied voltage. However, there was good correlation between the drop velocity and the presence of satellites. It was observed that, there existed a critical drop velocity beyond which drops have satellites, and below which there were no satellites. In the PEDOT system, the critical velocity was found to be about 7 m/s to about 8 m/s. Based on this critical velocity and the design requirement of minimum velocity of 3 m/s, the data was presented on a contour plot and a suitable operating region was identified for jetting. An optimum for PEDOT jetting was found at 100V and 9 microsecond pulse duration (drop velocity 7.6 m/s, no satellites) that was different from the initial starting conditions. However, when deposition was performed according to the predicted conditions, a uniform drop pattern with no satellites was obtained.

In order to make very thin films, it was determined that dilute solutions would be more suitable, i.e., with 1.6% solids. The viscosity of the solution was 10 mPas and was suitable for jetting. About 0.25% of surfactant (ETHOX 1437) was added for better wetting of the printhead. Jetting showed a higher drop velocity and more satellites at identical conditions with a 2.6 wt % PEDOT solution. Jetting devoid of satellite presence was obtained only under 80V, 10 microsecond pulse duration conditions. By suitable arrangements of the drops on the previously UV/ozone treated substrate, continuous and very uniform films could be obtained with 50-100 nm dry thickness by passing the substrate under the jetting printhead only once.

Other uniform films successfully formed by this method included polystryrene and ULTEM® 100 (polyimide) made from their solutions in anisole.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A chemical composition comprising an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid.

2. The chemical composition of claim 1, wherein the electroactive compound is selected from the group consisting of a light emitting polymer, a photovoltaic material, an organometallic compound, a charge transfer polymer, and combinations thereof.

3. The chemical composition of claim 2, wherein the light emitting polymer is selected from the group consisting of poly(n-vinylcarbazole) (“PVK”), polyfluorene, poly(alkylfluorene), poly(paraphenylene), poly(p-phenylene vinylene), polysilanes, polythiophene, poly(2,5-thienylene vinylene), poly(pyridine vinylene), polyquinoxaline, polyquinoline, 1,3,5-tris {n-(4-diphenylaminophenyl) phenylamino}benzene, phenylanthracene, tetraarylethene, coumarin, rubrene, tetraphenylbutadiene, anthracene, perylene, coronene, and derivatives thereof, aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metallic complexes of 8-hydroxyquinoline, and derivatives of organo-metalic complexes of 8-hydroxyquinoline, and combinations thereof.

4. The chemical composition of claim 1, wherein the electroactive compound is selected from the group consisting of polyethylenetdioxythiophene, poly(3,4-propylenedioxythiophene), and combinations thereof.

5. The chemical composition of claim 1, wherein the electroactive compound is formulated in a liquid carrier that is selected from the group consisting of water, isopropanol, ethylene glycol, a surfactant, anisole, tetralin, toluene, chlorobenzene, p-xylene, mesitylene, 4-methylanisole, orthodichlorobenzene, methyl benzilate, decalin, 1,2,3,5-tetramethyl benzene, methylbenzoate, alphaterpineol, and combinations thereof.

6. The chemical composition of claim 1, wherein the substrate is selected from the group consisting of paper, plastics, polymers, ceramics, metals, glass, composites, alloys, and combinations thereof.

7. The chemical composition of claim 1, wherein the drop of the liquid on the substrate has a contact angle in a range from 0 to about 5 degrees.

8. A method for depositing a chemical composition on a substrate, the method comprising:
a) providing the substrate;
b) providing the chemical composition that comprises an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid;
c) discharging a jet of the chemical composition from a nozzle, the jet having a velocity in a range from about 1 to about 10 m/s at the nozzle; and
d) allowing the jet to impinge on the substrate.

9. The method of claim 8, wherein the substrate is selected from the group consisting of paper, plastics, polymers, ceramics, metals, glass, composites, alloys, and combinations thereof.

10. The method of claim 8, wherein the electroactive compound is selected from the group consisting of a light emitting polymer, a photovoltaic material, an organometallic compound, a charge transfer polymer, and combinations thereof.

11. The method of claim 10, wherein the light emitting polymer is selected from the group consisting of poly(n-vinylcarbazole) (“PVK”), polyfluorene, poly(alkylfluorene), poly(paraphenylene), poly(p-phenylene vinylene), polysilanes, polythiophene, poly(2,5-thienylene vinylene), poly(pyridine vinylene), polyquinoxaline, polyquinoline, 1,3,5-tris {n-(4-diphenylaminophenyl) phenylamino}benzene, phenylanthracene, tetraarylethene, coumarin, rubrene, tetraphenylbutadiene, anthracene, perylene, coronene, and derivatives thereof, aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metallic complexes of 8-hydroxyquinoline, and derivatives of organo-metalic complexes of 8-hydroxyquinoline, and combinations thereof.

12. The method of claim 8, wherein the electroactive compound is selected from the group consisting of polyethylenedioxythiophene, poly(3,4-propylenedioxythiophene), and combinations thereof.

13. The method of claim 8, wherein the electroactive compound is formulated in a liquid carrier that is selected from the group consisting of water, isopropanol, ethylene glycol, a surfactant, anisole, tetralin, toluene, chlorobenzene, p-xylene, mesitylene, 4-methylanisole, orthodichlorobenzene, methyl benzilate, decalin, 1,2,3,5-tetramethyl benzene, methylbenzoate, alphaterpineol, and combinations thereof.

14. A method of forming a substantially continuous film of a chemical composition on a substrate, the method comprising:
a) providing the substrate;
b) providing the chemical composition that comprises an electroactive compound in a liquid form such that a drop of the liquid on a substrate has a contact angle in a range from 0 to about 20 degrees, the liquid having a viscosity in a range from about 2 to about 20 mPas, the liquid having a boiling point in a range from about 100° C. to about 200° C., and the concentration of the electroactive compound in the liquid being in a range from about 0.01 to about 4 grams of the electroactive compound per cubic centimeter of liquid;
c) discharging substantially simultaneously a plurality of jets of the chemical composition from a plurality of nozzles, each jet having a velocity in a range from about 1 to about 10 m/s at a nozzle; and
d) allowing the jets to impinge on the substrate to form a plurality of interconnected drops, thereby forming the substantially continuous film of the chemical composition.

15. The method of claim 14, wherein the substrate is selected from the group consisting of paper, plastics, polymers, ceramics, metals, glass, composites, alloys, and combinations thereof.

16. The method of claim 14, wherein the electroactive compound is selected from the group consisting of a light emitting polymer, a photovoltaic material, an organometallic compound, a charge transfer polymer, and combinations thereof.

17. The method of claim 16, wherein the light emitting polymer is selected from the group consisting of poly(n-vinylcarbazole) (“PVK”), polyfluorene, poly(alkylfluorene), poly(paraphenylene), poly(p-phenylene vinylene), polysilanes, polythiophene, poly(2,5-thienylene vinylene), poly(pyridine vinylene), polyquinoxaline, polyquinoline, 1,3,5-tris {n-(4-diphenylaminophenyl) phenylamino}benzene, phenylanthracene, tetraarylethene, coumarin, rubrene, tetraphenylbutadiene, anthracene, perylene, coronene, and derivatives thereof, aluminum-acetylacetonate, gallium-acetylacetonate, and indium-acetylacetonate, aluminum-(picolymethylketone)-bis {2,6-di(t-butyl)phenoxide}, scandium-(4-methoxy-picolylmethylketone)-bis(acetylacetonate), organo-metallic complexes of 8-hydroxyquinoline, and derivatives of organo-metalic complexes of 8-hydroxyquinoline, and combinations thereof.

18. The method of claim 14, wherein the electroactive compound is selected from the group consisting of polyethylenetdioxythiophene, poly(3,4-propylenedioxythiophene), and combinations thereof.

19. The method of claim 14, wherein the electroactive compound is formulated in a liquid carrier that is selected from the group consisting of water, isopropanol, ethylene glycol, a surfactant, anisole, tetralin, toluene, chlorobenzene, p-xylene, mesitylene, 4-methylanisole, orthodichlorobenzene, methyl benzilate, decalin, 1,2,3,5-tetramethyl benzene, methylbenzoate, alphaterpineol, and combinations thereof.

20. The method of claim 14, wherein the drop of the liquid on the substrate has a contact angle in a range from 0 to about 5 degrees.
